(19) United States
(12) Patent Application Publication
(10) Pub. No.: US 2009/0067733 A1
(43) Pub. Date: Mar. 12, 2009

(54) Byte Representation for Enhanced Image Compression

(75) Inventor: Massimo Ballerini, Milano (IT)

Correspondence Address: FISH & RICHARDSON, PC, P.O. BOX 1022, MINNEAPOLIS, MN, 55440-1022, US

(73) Assignee: RGB LIGHT LIMITED, Tortola (IT)

(21) Appl. No.: 12/209,152

(22) Filed: Sep. 11, 2008

Related U.S. Application Data
(60) Provisional application No. 60/971,485, filed on Sep. 11, 2007.

(51) Int. Cl. G10L 15/00

(52) U.S. Cl. 382/237

(57) ABSTRACT

Various aspects can be implemented to enhance image compression by using a byte representation to reduce the color values and increase redundancy in the color information. In general, one aspect can be a method for enhancing compression of a digital image having a plurality of pixels, each pixel including at least one color component, the method includes obtaining an original number of bits for representing a color value associated with the at least one color component. The method also includes assigning a first reduced number of bits for representing a plurality of case attributes. The method further includes assigning a second reduced number of bits for representing a new color value, wherein the sum of the first reduced number of bits and the second reduced number of bits equals the original number of bits. Other implementations of this aspect include corresponding systems, apparatus, and computer program products.

### CROSS-REFERENCE TO RELATED APPLICATIONS

This application claims the benefit of priority from U.S. Provisional Patent Application No. 60/971,485, entitled Byte Representation for Enhanced Image Compression, filed Sep. 11, 2007, which is incorporated by reference in its entirety.

### TECHNICAL FIELD

This disclosure generally relates to enhancing image compression (both lossless and lossy compressions) using a byte representation.

### BACKGROUND

Conventional image compression techniques are generally referred to as being either “lossless” or “lossy”, depending upon whether data is discarded in the compression process. Examples of conventional lossless compression techniques include Huffman encoding, arithmetic encoding, and Fano-Shannon encoding. With a lossless compression, the decompression process will reproduce the entire original image. Lossless compression can be important for images found in such applications as medical and space science. In such situations, the compression algorithm is implemented to avoid discarding any information that may be required or even useful at some later point when a compressed image is to be decompressed.

Lossy compression, on the other hand, provides greater efficiency over lossless compression in terms of speed and storage, as some data is discarded. As a result, lossy techniques are employed where some degree of inaccuracy relative to the input data is tolerable. For example, lossy compression is frequently used in video or commercial image processing. Two popular lossy image compression standards are the MPEG (Motion Picture Experts Group) and JPEG (Joint Photographic Experts Group) compression methods.

In addition to imaging systems, compression technology can be incorporated into video servers for “video on demand” applications. Compression technology can also be applied to streaming video, for example, the real-time capture and display of video images over a communications link. Applications for streaming video can include video telephones, remote security systems, and other types of monitoring systems.

### SUMMARY

This specification describes various aspects relating to enhancing image compression for both lossless and lossy compressions using a byte representation to reduce the color values and increase redundancy in the color information. Compression algorithms typically reduce the data size by eliminating redundant information in a digital format. Therefore, an increased redundancy using the byte representation can allow the lossless image compressor to perform compression more efficiently and reduce the amount of bandwidth required to store data. The byte representation can be applied to data files for images (e.g., bitmap images) or other digital objects.

In general, one aspect can be a method for enhancing compression of a digital image having a plurality of pixels, each pixel including at least one color component, the method includes obtaining an original number of bits for representing a color value associated with the at least one color component. The method also includes assigning a first reduced number of bits for representing a plurality of case attributes. The method further includes assigning a second reduced number of bits for representing a new color value, wherein the sum of the first reduced number of bits and the second reduced number of bits equals the original number of bits. Other implementations of this aspect include corresponding systems, apparatus, and computer program products.

Another general aspect can be a method for enhancing compression of a digital image having a plurality of pixels, each pixel including at least one color component, the method includes obtaining a first range of color values associated with the at least one color component. The method also includes assigning the first range of color values into a plurality of case attributes. The method further includes determining a second range of color values based in part on the plurality of case attributes, the second range being substantially smaller than the first range; and wherein the product of the second range and the plurality of case attributes equals the first range. Other implementations of this aspect include corresponding systems, apparatus, and computer program products.

Yet another general aspect can be a system that includes a transformation module configured to perform color space transformation from an RGB color space into a new color space. The system also includes a coding module configured to perform a predictive coding. The system further includes means for increasing redundancy in color values using a byte representation based on a plurality of case attributes and a new color value. The system includes an image compressor configured to perform image compression based on the byte representation.

These and other general aspects can optionally include one or more of the following specific aspects. The method can include obtaining an original color value associated with a pixel of the digital image. The method can also include determining a case attribute from the plurality of case attributes based in part on the original color value. The method can further include determining a new color value based on the case attribute and the original color value, wherein the new color value is substantially smaller than the original color value; and wherein the original color value is represented by the new color value and the case attribute. The method can yet further include storing the case attribute and the new color value in a binary format.

In one implementation, the original number of bits is based on 8 bits; the first reduced number of bits is based on 3 bits, and the second reduced number of bits is based on 5 bits. In another implementation, the original number of bits is based on 8 bits; the first reduced number of bits is based on 2 bits, and the second reduced number of bits is based on 6 bits. In a further implementation, the original number of bits is based on 11 bits; the first reduced number of bits is based on 3 bits, and the second reduced number of bits is based on 8 bits.

In some implementations, the at least one color component includes Red, Green, or Blue color component of an RGB color space. In one implementation, the first range includes 256 color values, the plurality of case attributes includes 8 case attributes, and the second range includes 32 color values. In another implementation, the first range includes 256 color values, the plurality of case attributes includes 16 case attributes, and the second range includes 16 color values. In yet another implementation, the first range includes 256 color values, the plurality of case attributes includes 4 case attributes, and the second range includes 64 color values.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is a flow chart illustrating how the byte representation can be implemented to enhance a lossless compression algorithm.

FIG. 2A is a conceptual drawing of how an original color value can be converted into a case attribute number and a new color value using the byte representation.

FIG. 2B is a table showing the conversion of a traditional color value into a case attribute number in the byte representation.

FIG. 2C is a table showing the redundancy of case attribute numbers and new color values using the byte representation.

FIG. 3A is a flow chart illustrating a process for converting a traditional color value into a byte representation.

FIG. 3B is a flow chart illustrating a process for reconstructing the original color value from the byte representation.

FIG. 4A is a table showing residual prediction values used in JPEG compression.

FIG. 4B is a table showing the conversion of the residual prediction values for each category into a case attribute number in the byte representation.

FIG. 5 is a flow chart illustrating how the byte representation can be implemented to enhance the dark method encoding algorithm.

FIG. 6 illustrates the advantages of using the byte representation to enhance image compression.

FIG. 7 is a block diagram of a computing device and system used to implement the enhanced image compression using the byte representation.

Like reference symbols in the various drawings indicate like elements.

### DETAILED DESCRIPTION

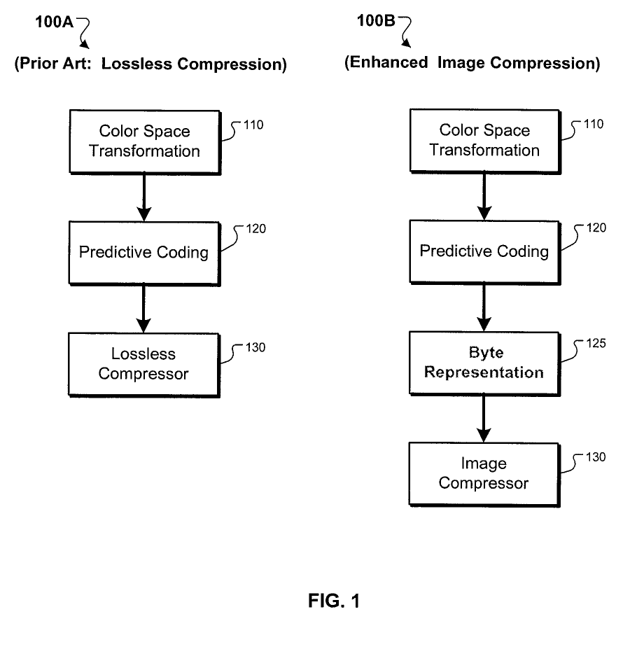

FIG. 1 is a flow chart illustrating how the byte representation can be implemented to enhance a lossless compression algorithm. Process 100A describes the steps involved in applying a typical lossless compression algorithm to a digital image. For example, at 110 a color space transformation is performed on the original digital image. In one implementation, when the original digital image is represented by the RGB color space, step 110 can transform the RGB color space into another color space, such as YCᵣC_{b} or YC_{g}C_{b}, for example. At 120, a predictive coding algorithm is applied to the transformed color space. Predictive coding can be used to remove redundancy between successive pixels. Additionally, the residual between actual and predicted values can be encoded. Once the predictive coding algorithm has been applied, at 130, a lossless compression algorithm is used to reduce the size of the digital image. For example, the lossless compression algorithm can be run-length encoding (RLE), Lempel-Ziv-Welch (LZW) compression, all topology of the zip or rar (e.g., bzip, 7zip, Pkzip, winace), and the like.

Process 100B describes the steps involved in applying the byte representation in an image compression algorithm (which can be any type of compression algorithm) to enhance the compression of a digital image. In one implementation, once the predictive coding algorithm has been applied and before the image compressor (which can be any type of lossy or lossless compressor) is implemented, the byte representation can be used to create more redundancy in the digital image. Details of the byte representation will be discussed further below.

The byte representation can be used to change the representation of color information by creating more redundancy in the color information without losing information. The process of obtaining a byte representation can be described using a 24-bit color image as an example. The amount of available composite colors depends on the number of bits used for each primary color component. Typical modern day computer displays use a total of 24 bits of information for each pixel, a format referred to as “24-bit true color.” This corresponds to 8 bits each for red, green, and blue, giving a range of 256 possible tones or color values for each primary color. With the 24-bit true color scheme, approximately 16.7 million discrete colors can be reproduced, even though human vision can distinguish only among about 10 million discrete colors. The human visual response varies from person to person depending upon the condition of eye and the age of person.

As noted above, each color can be represented by 8 bits (or 1 byte), thereby allowing 256 possible color values using the binary representation. In one implementation, the 256 color values can be transformed into a byte representation comprising two substructures, where one substructure contains the new color values, and the other substructure contains the case attribute of the new color values. For example, for a given byte representation of data, one can choose 7 bits for one substructure (e.g., new color value) and 1 bit for the other substructure (e.g., case attribute). Additionally, the breakdown of number of bits for each substructure can be 6 bits+2 bits, 5 bits+3 bits, 4 bits+4 bits, and the like.

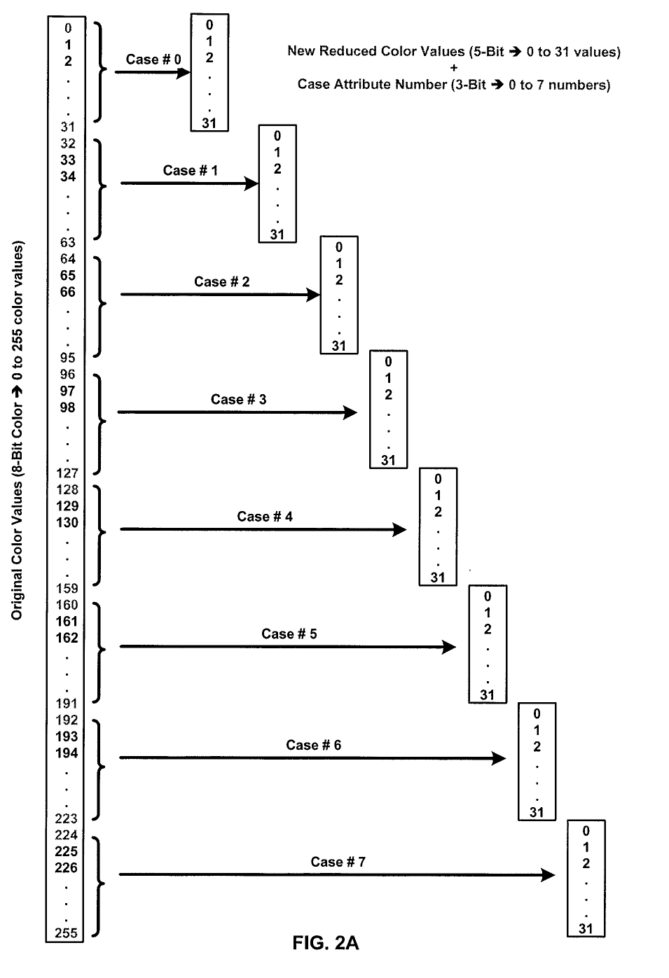

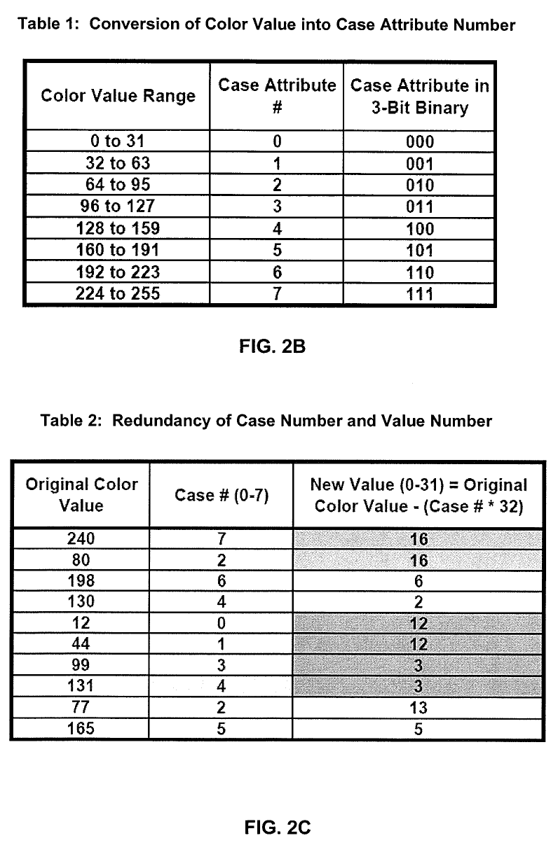

FIG. 2A is a conceptual drawing of how an original color value can be converted into a new color value with a case attribute number and new color value using the byte representation. In some implementations the 5 bits+3 bits representation of substructures for new color value and attribute can be preferred. In the binary system, the first 5 bits can be used to represent a maximum number of 32 new color values. Additionally, for the remaining 3 bits, a maximum number of 8 case attributes can be obtained. Thus, the original 256 color values can be represented by 32 possible new color values (as denoted by the first 5 bits) along with one of 8 possible case attributes (as denoted by the last 3 bits). In this manner, the amount of redundancy in the color values can be increased because there are now less possible color values (32 as opposed to 256) representing each color.

As an example, FIG. 2B shows how the original 256 color values can be assigned to one of eight possible case attributes. For example, if the original color value is in the range of between 0 to 31, then the color value can be assigned a case attribute number of 0, with a corresponding 3-bit binary representation of “000.” Similarly, if the original color value is in the range of between 192 to 223, then the color value can be assigned a case attribute number of 6, with a corresponding 3-bit binary representation of “110.”

FIG. 2C is a table that shows the redundancy of case attribute numbers and color values using the byte representation. As described above (e.g., FIG. 2A), each of the original color values (0 to 255) can be represented by a case attribute number (0 to 7) and a new color value (0 to 31). For example, if the original color value is 240, using the conversion table of FIG. 2B, a case attribute number of 7 can be obtained because 240 falls within the range of 224 to 255. Additionally, within case attribute #7, a new color value (ranging from 0 to 31) can be determined using the following formula: New Color Value=Original Color Value−(Case Attribute Number*32). Therefore, the original color value of 240 can be transformed into a new color value of 16, which is 240−(7*32)=16. In this manner, the original color value of 240 can be represented by a new color value of 16, with a case attribute number of 7.

Additionally, if the original color value is 80, using the conversion table of FIG. 2B, a case attribute number of 2 can be obtained because 80 falls within the range of 64 to 95. Furthermore, using the formula stated above, a new color value of 16 can be assigned to the original color value of 80. In this manner, the original color value of 80 can be represented by a new color value 16, with a case attribute number of 2. It is important to note that original color values 80 and 240 both have the same new color value of 16. Therefore, the byte representation can increase the number of redundancy based on the new color value because the range has been reduced from 0-255 to 0-31. For example, original color values 12 and 44 both have the same new color value of 12 using the byte representation. Additionally, original color values 99 and 131 both have the same new color value of 3 using the byte representation.

Furthermore, the byte representation can also increase the number of redundancy based on the case attribute number. For example, original color values 77 and 80 both have the same case attribute number of 2 using the byte representation. Additionally, original color values 130 and 131 both have the same case attribute number of 4 using the byte representation. In this manner, Table 2 of FIG. 2C shows the power of the byte representation in creating redundancy in the color information. For example, for the 10 original non-redundant color values, there are 2 redundancies in the case attribute numbers and 3 redundancies in the new color values. Therefore, the efficiency of an image compressor can be enhanced because there can be more data redundancies using the byte representation.

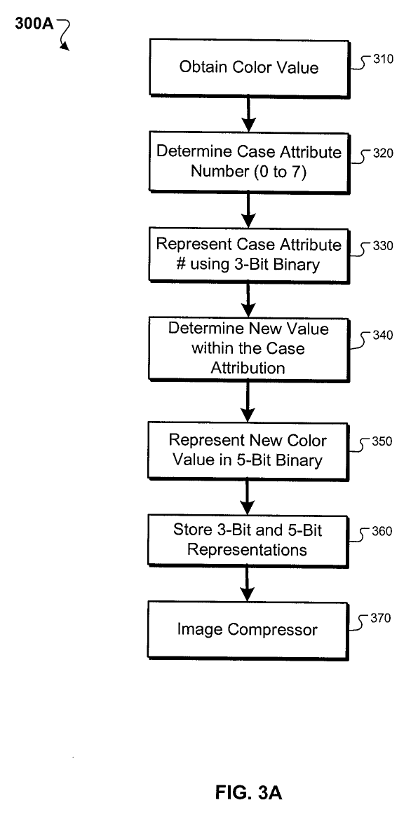

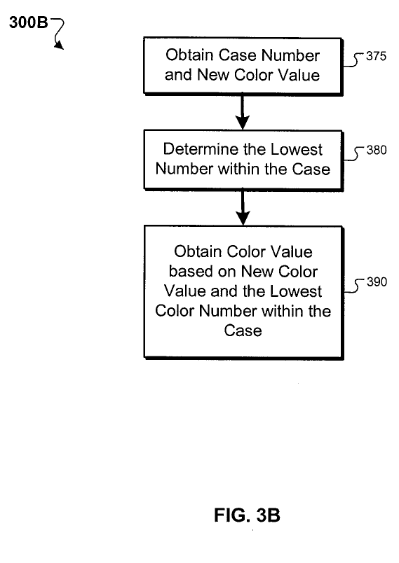

FIG. 3A is a flow chart illustrating a process 300A for converting a traditional color value into a byte representation. At 310, process 300A obtains color values associated with a digital image, which can be a still image, a video image, digital objects, and the like. Additionally, as noted above, the image compression algorithm will typically perform a space color transformation prior to step 310. At 320, process 300A determines the case attribute number associated with the obtained color value. For example, referring back to FIG. 2B, if the obtained color value falls within the range of 64 to 95, then process 300A will assign a case attribute number of 2 to the obtained color value. Once the case attribute number has been determined, at 330, process 300A can represent the case attribute number using a 3-bit binary format. For example, in the case attribute number is 2, then the 3-bit binary representation is “010.”

Next, process 300A determines the new color value, which ranges from 0 to 31, within the case attribution. As noted above, the new color value can be determined using the following formula: New Color Value=Original Color Value−(Case Attribute Number*32). For example, referring back to FIG. 2C, if the original color value is 130, process 300A can determine that the case attribute number should be 4 because 130 falls within the range of 128 to 159. Additionally, using the determined case attribute number, process 300A can calculate the new color value to be 2. In this manner, the original color value of 130 can be represent a with a new color value of 2, and a case attribute number of 4. At 350, process 300A represents the new color value using a 5-bit binary number. For example, for a new color value of 2 the 5-bit binary number is “100010.”

Once the original color value has been converted to a new color value along with a case attribute number using the byte representation, at 360, process 300A stores the 3-bit (case attribute number) and the 5-bit (new color value) representations into a storage device, which can be, e.g., a computer memory or a flash drive. Additionally, the stored byte representation can be used as an input to an image compressor, which can be, e.g., any type of lossless or lossy compressor.

FIG. 3B is a flow chart illustrating a process 300B for reconstructing the original color value from the byte representation. At 375, process 300B obtains the case attribute number and the new color value of the byte representation. For example, referring back to FIG. 2C, suppose that process 300B obtains a case attribute number of 2 and a new color value of 13. At 380, process 300B determines the lowest number of color value within the range associated with the case attribute number, e.g., as shown in Table 1 of FIG. 2B. For example, FIG. 2B shows that the case attribute number 2 has the lowest number of 64. Next, process 300B, at 390, determines the original color value based on the lowest number of color value and the new color value. For example, given that the lowest number is 64 and the new color value is 13, process 300B can determine that the original color value is 77, which is 64+13=77. Similarly, a case attribute number of 5 (which has a lowest number of 160 within the range associated with case attribute number 5) and a new color value of 5 can be used to reconstruct the original color value of 165, which is 160+5=165.

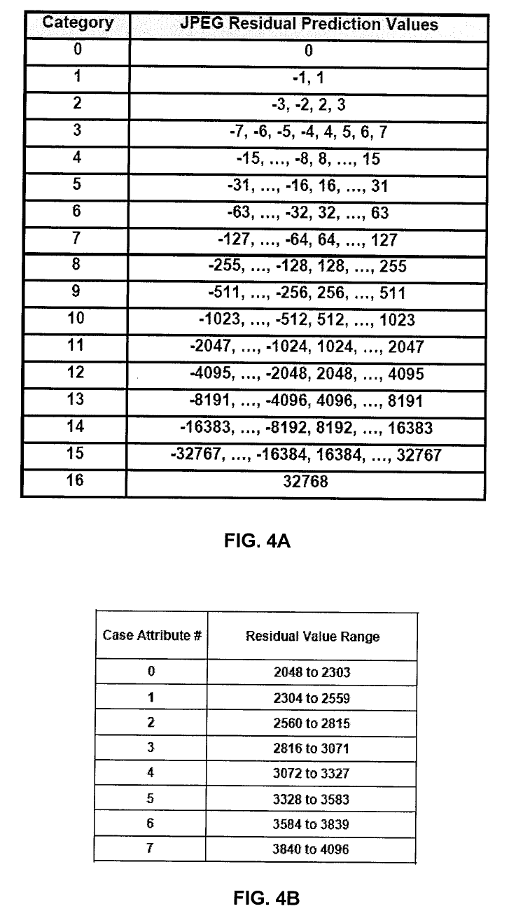

FIG. 4A is a table showing residual prediction values used in JPEG compression. FIG. 4A shows 17 categories (category 0 to category 16) of residual prediction values. For example, category 1 has residual values of −1 or 1; category 6 has residual values of −63 to −32 and 32 to 63. Additionally, category 15 has residual values of −32767 to −16384 and 16384 to 32767; and category 16 has a residual value of 32768.

As noted above, the byte representation can be used to increase redundancy in the encoding of digital image. For example, category 15 of FIG. 4A has residual values of −32767 to −16384 and 16384 to 32767, which gives 16,394 different and independent residual values. Using the byte representation and converting 16,394 residual values into 8 different case attributes, a range of 2048 case residual values can be obtained.

FIG. 4B is a table showing the conversion of the residual prediction values for each category into a case attribute number in the byte representation. For example, case attribute #0 can be used to represent residual values in the range of 2048 to 2303; case attribute #1 can be used to represent residual values in the range of 2304 to 2559, and so forth. In this manner, the original 16,394 residual values of category 15 (as shown in FIG. 4A) can be reduced to 256 new residual values (8-bit representation) with 8 different case attributes (3-bit representation).

As an example, suppose that the residual prediction number is 23,456. Using FIG. 4A, one can determine that the residual prediction value falls within the range of category 15. Additionally, by dividing 23,456 by 8, one can obtain a value of 2,932. Using FIG. 4B, one can determine that the new residual prediction value (2,932) falls within the range of case attribute #3 (2816 to 3071). Additionally, a new value can be determined using the following formula: New Residual Value=Case Residual Value−((Case Attribute Number+8)*256). In other words, the new residual value for 2932 is 116, which is 2932−((3+8)*256)=116. In this manner, an input data for the image compressor can simply be 15-3-116 (Category 15; Case Attribute #3; New Residual Value of 116). As a result of the reduced range of residual values (from 16,384 down to 256), there can be more redundancy in the encoding of the digital image.

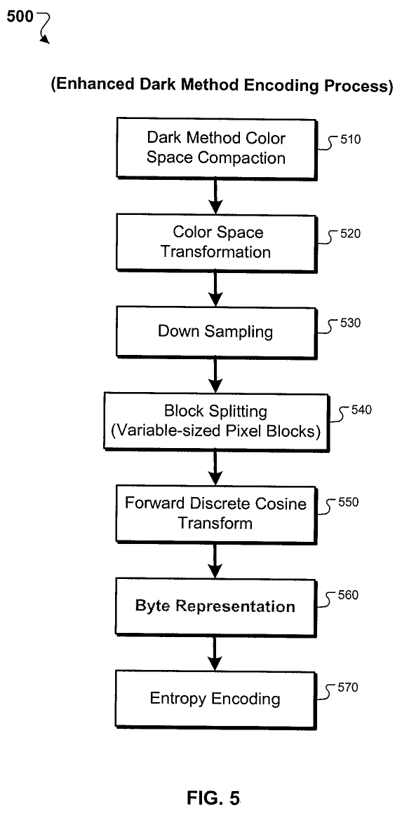

FIG. 5 is a flow chart illustrating a process 500 that uses the byte representation to enhance the dark method encoding algorithm. Details of the dark method encoding process can be found in a co-pending application entitled “Image Enhancement and Compression,” which is a PCT application filed on Sep. 14, 2006. The dark method encoding algorithm is a lossy compression algorithm, and using the byte representation, digital image compression can be enhanced even further without losing image quality. For example, the byte representation can be incorporated after the forward discrete cosine transform step 550 in the dark method encoding process.

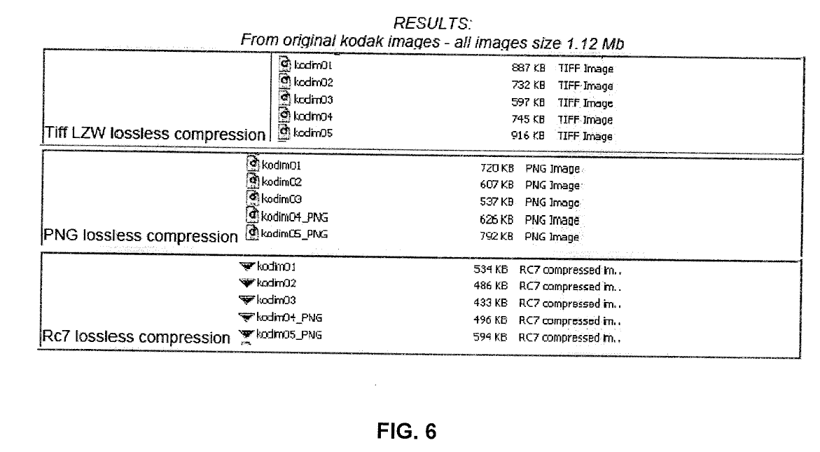

FIG. 6 illustrates the advantages of using the byte representation to enhance image compression. In one implementation, a beta software package named CPD (compressor photo definer) was used to demonstrate the ability to further reduce image size based on the byte representation. The CPD software package can read data from various original image formats, for example, bmp, tiff, pcx, targa, ras, and the like. As described above, the CPD can translate the received image format into 24-bit true color RGB format. After that, a software package performs a color space transformation by converting from the RGB color space into, e.g., the YCrCb color space. Additionally, the software package applies a predictive coding algorithm. Lastly, the software package uses a lossless compressor to perform image compression. In one implementation, the byte representation as described above can be implemented in the software package before the lossless compression. Therefore, compressed images having the byte representation are saved in a Rc7 or CPD file format.

As an example, an original image with an image size of 1.12 MB was compressed using three different lossless compression algorithms: Tiff-LZW, PNG, and CPD. As shown in FIG. 6, for example for the image file named “kodim01,” Tiff-LZW lossless compression obtains a compressed image size of 887 kb; PNG lossless compression obtains a compressed image size of 720 kb; and Rc7 (or CPD) lossless compression (which incorporates the byte representation) obtains a compressed image size of 534 kb. Therefore, the CPD lossless compression format can produce an image compression size that is over 25% smaller than the traditional compression algorithms.

The Rc7 or CPD lossless compression can also achieve a substantial improvement when compared with a commercially available software package such as WinZip. For example, for a Bitmap image with a file size of 193 kb, the zipped compression format only reduces the file size to 163 kb, and the 7zip compression format only reduces the file size to 144 kb. In contrast, using the Rc7 or CPD lossless compression algorithm, which incorporates the byte representation to increase data redundancy and enhance image compression, the original file size of 193 kb was reduced down to 97 kb. This is almost a 50% improvement over WinZip's capability in compressing a bitmap file.

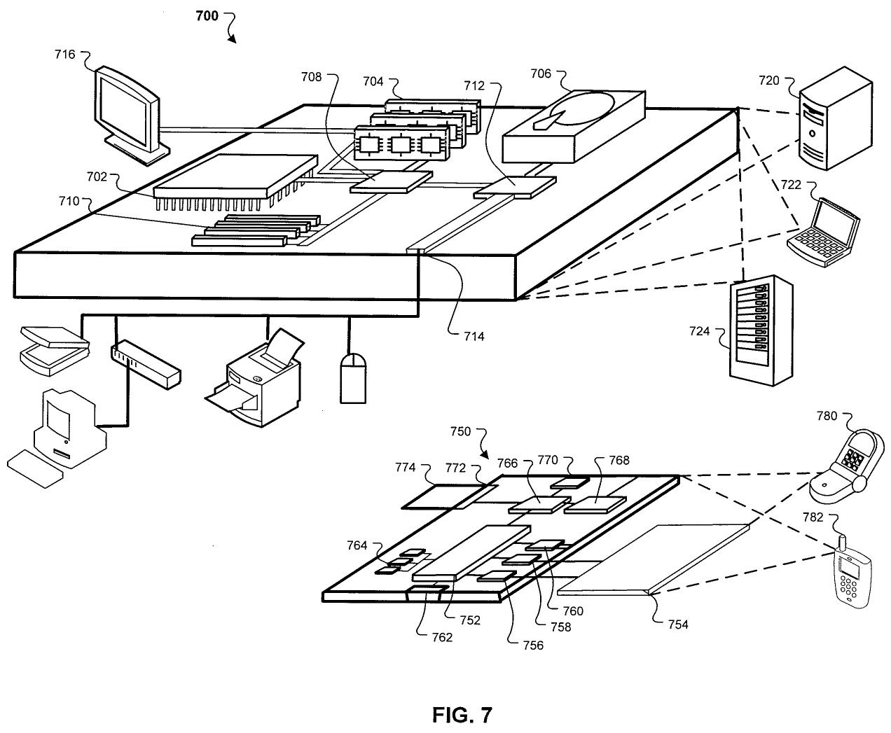

FIG. 7 is a block diagram of a computing device and system that can be used, e.g., to implement the enhanced image compression. Computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708.

In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system). The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the described embodiments. Accordingly, other embodiments are within the scope of the following claims.

What is claimed is:

1. A computer-implemented method for enhancing compression of a digital image having a plurality of pixels, each pixel including at least one color component, the method comprising:
obtaining an original number of bits for representing a color value associated with the at least one color component;
assigning a first reduced number of bits for representing a plurality of case attributes; and
assigning a second reduced number of bits for representing a new color value, wherein the sum of the first reduced number of bits and the second reduced number of bits equals the original number of bits.

2. The method of claim 1, further comprising:
obtaining an original color value associated with a pixel of the digital image;
determining a case attribute from the plurality of case attributes based in part on the original color value;
determining a new color value based on the case attribute and the original color value, wherein the new color value is substantially smaller than the original color value; and
wherein the original color value is represented by the new color value and the case attribute.

3. The method of claim 2, further comprising:
storing the case attribute and the new color value in a binary format.

4. The method of claim 1, wherein the original number of bits includes 8 bits; wherein the first reduced number of bits includes 3 bits; and wherein the second reduced number of bits includes 5 bits.

5. The method of claim 1, wherein the original number of bits includes 8 bits; wherein the first reduced number of bits includes 2 bits; and wherein the second reduced number of bits includes 6 bits.

6. The method of claim 1, wherein the original number of bits includes 11 bits; wherein the first reduced number of bits includes 3 bits; and wherein the second reduced number of bits includes 8 bits.

7. A computer-implemented method for enhancing compression of a digital image having a plurality of pixels, each pixel including at least one color component, the method comprising:
obtaining a first range of color values associated with the at least one color component;
assigning the first range of color values into a plurality of case attributes;
determining a second range of color values based in part on the plurality of case attributes, the second range being substantially smaller than the first range; and
wherein the product of the second range and the plurality of case attributes equals the first range.

8. The method of claim 7, wherein the at least one color component comprises Red, Green, or Blue color component of an RGB color space.

9. The method of claim 7, wherein the first range includes 256 color values, wherein the plurality of case attributes includes 8 case attributes; and wherein the second range includes 32 color values.

10. The method of claim 7, wherein the first range includes 256 color values, wherein the plurality of case attributes includes 16 case attributes; and wherein the second range includes 16 color values.

11. The method of claim 7, wherein the first range includes 256 color values, wherein the plurality of case attributes includes 4 case attributes; and wherein the second range includes 64 color values.

12. A computer program product, encoded on a computer-readable medium, operable for enhancing compression of a digital image having a plurality of pixels, each pixel including at least one color component, and to cause data processing apparatus to perform operations comprising:
obtaining an original number of bits for representing a color value associated with the at least one color component;
assigning a first reduced number of bits for representing a plurality of case attributes; and
assigning a second reduced number of bits for representing a new color value, wherein the sum of the first reduced number of bits and the second reduced number of bits equals the original number of bits.

13. The computer program product of claim 12, to cause data processing apparatus to perform further operations comprising:
obtaining an original color value associated with a pixel of the digital image;
determining a case attribute from the plurality of case attributes based in part on the original color value;
determining a new color value based on the case attribute and the original color value, wherein the new color value is substantially smaller than the original color value; and
wherein the original color value is represented by the new color value and the case attribute.

14. The computer program product of claim 13, to cause data processing apparatus to perform further operations comprising:
storing the case attribute and the new color value in a binary format.

15. The computer program product of claim 12, wherein the original number of bits includes 8 bits; wherein the first reduced number of bits includes 3 bits; and wherein the second reduced number of bits includes 5 bits.

16. The computer program product of claim 12, wherein the original number of bits includes 8 bits; wherein the first reduced number of bits includes 2 bits; and wherein the second reduced number of bits includes 6 bits.

17. The computer program product of claim 12, wherein the original number of bits includes 11 bits; wherein the first reduced number of bits includes 3 bits; and wherein the second reduced number of bits includes 8 bits.

18. A computer program product, encoded on a computer-readable medium, operable for enhancing compression of a digital image having a plurality of pixels, each pixel including at least one color component, and to cause data processing apparatus to perform operations comprising:
obtaining a first range of color values associated with the at least one color component;
assigning the first range of color values into a plurality of case attributes;
determining a second range of color values based in part on the plurality of case attributes, the second range being substantially smaller than the first range; and
wherein the product of the second range and the plurality of case attributes equals the first range.

19. The computer program product of claim 18, wherein the at least one color component comprises Red, Green, or Blue color component of an RGB color space.

20. The computer program product of claim 18, wherein the first range includes 256 color values, wherein the plurality of case attributes includes 8 case attributes; and wherein the second range includes 32 color values.

21. The computer program product of claim 18, wherein the first range includes 256 color values, wherein the plurality of case attributes includes 16 case attributes; and wherein the second range includes 16 color values.

22. The computer program product of claim 18, wherein the first range includes 256 color values, wherein the plurality of case attributes includes 4 case attributes; and wherein the second range includes 64 color values.

23. A system comprising:
a transformation module configured to perform color space transformation from an RGB color space into a new color space;
a coding module configured to perform a predictive coding;
means for increasing redundancy in color values using a byte representation based on a plurality of case attributes and a new color value; and
an image compressor configured to perform image compression based on the byte representation.
